(19) United States
(12) Patent Application Publication
(10) Pub. No.: US 2009/0174155 A1
(43) Pub. Date: Jul. 9, 2009

(54) Heat-Insulating Sealing Device

(75) Inventors: Ming-Hui Yu, Taipei City (TW); Chia-Jung Kao, Taipei City (TW); A-Tzu Chen, Jhonghe City (TW)

Correspondence Address: THE WEBB LAW FIRM, P.C., 700 KOPPERS BUILDING, 436 SEVENTH AVENUE, PITTSBURGH, PA, 15219, US

(73) Assignee: TANGTECK EQUIPMENT INC., Dayuan Township (TW)

(21) Appl. No.: 12/338,315

(22) Filed: Dec. 18, 2008

(30) Foreign Application Priority Data
Jan. 3, 2008 (TW) 097100172

(51) Int. Cl. F16J 15/10

(52) U.S. Cl. 277/650

(57) ABSTRACT

A heat-insulating sealing device is mountable between a bottom face of an openable top cover and a top face of a furnace bottom of a heating furnace which defines a furnace chamber. The heat-insulating sealing device includes outer and inner looped sealing strips adapted to surround the furnace chamber and adapted to provide a seal between the top cover and the furnace bottom. The outer looped sealing strip extends around the inner looped sealing strip, is made of a heat-resistant resilient polymeric material, and is adapted to be disposed distal from the furnace chamber. The inner looped sealing strip abuts against an inner side of the outer looped sealing strip, is adapted to extend around the furnace chamber, and includes a heat-resistant fabric.

### CROSS-REFERENCE TO RELATED APPLICATION

This application claims priority of Taiwanese Application No. 097100172, filed on Jan. 3, 2008.

### BACKGROUND OF THE INVENTION

1. Field of the Invention

This invention relates to a heat-insulating sealing device for a heating furnace having an openable top cover.

2. Description of the Related Art

Referring to FIG. 1, a circuit board (not shown) is sent to a conventional heating furnace 1 after electronic components are welded to the circuit board so as to cure the welding points. The conventional heating furnace 1 includes a furnace bottom 11, a conveying channel 12 formed in the furnace bottom 11 to convey a circuit board, an openable top cover 13 covering a top portion of the furnace bottom 11, and a heat-insulating sealing device 14 disposed between the furnace bottom 11 and the top cover 13. The furnace bottom 11 and the top cover 13 cooperatively define a furnace chamber 15. The heat-insulating sealing device 14 includes a flexible looped sealing strip 141 surrounding the furnace chamber 15 and fixed to a top face of the furnace bottom 11 to effect sealing of the furnace chamber 15.

During operation of the conventional heating furnace 1, the top cover 13 covers the top portion of the furnace bottom 11, and presses downwardly the looped sealing strip 141 so as to deform the same, so that the furnace chamber 15 is insulated and sealed. However, since the looped sealing strip 141 is directly heated by hot air emitted from the furnace chamber 15, it easily loses its structural integrity and its flexibility. This adversely affects the insulation and sealing quality of the conventional heating furnace 1. Further, the service life of the heat-insulating sealing device 14 is shortened.

### SUMMARY OF THE INVENTION

Therefore, the object of the present invention is to provide a heat-insulating sealing device for a heating furnace that is capable of overcoming the aforementioned drawbacks of the prior art.

According to this invention, a heat-insulating sealing device is mountable between a bottom face of an openable top cover and a top face of a furnace bottom of a heating furnace which defines a furnace chamber. The heat-insulating sealing device comprises outer and inner looped sealing strips adapted to surround the furnace chamber and adapted to provide a seal between the top cover and the furnace bottom, The outer looped sealing strip extends around the inner looped sealing strip, is made of a heat-resistant resilient polymeric material, and is adapted to be disposed distal from the furnace chamber. The inner looped sealing strip abuts against an inner side of the outer looped sealing strip, is adapted to extend around the furnace chamber, and includes a heat-resistant fabric.

### BRIEF DESCRIPTION OF THE DRAWINGS

Other features and advantages of the present invention will become apparent in the following detailed description of the preferred embodiment of the invention, with reference to the accompanying drawings, in which:

FIG. 1 is a perspective view of a conventional heating furnace with an openable top cover;

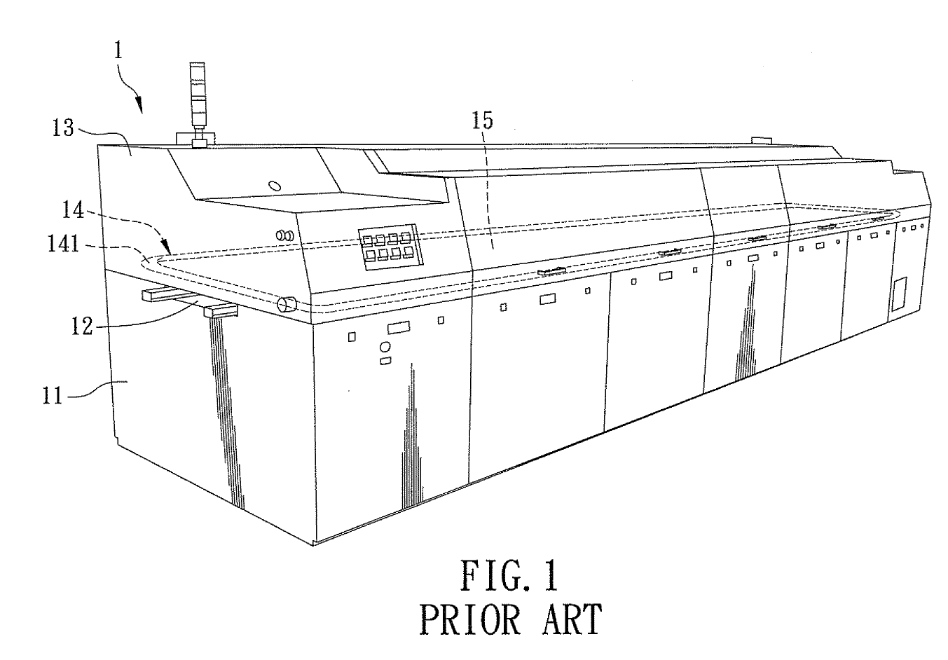

FIG. 2 is a fragmentary perspective view of a heating furnace having an openable top cover and incorporating a heat-insulating sealing device according to the preferred embodiment of the present invention;

FIG. 3 is a sectional side view of the preferred embodiment in a pressed state;

FIG. 4 is a fragmentary sectional view of inner and outer looped sealing strips of the preferred embodiment; and

FIG. 5 is a sectional view of the preferred embodiment in a released state.

### DETAILED DESCRIPTION OF THE PREFERRED EMBODIMENT

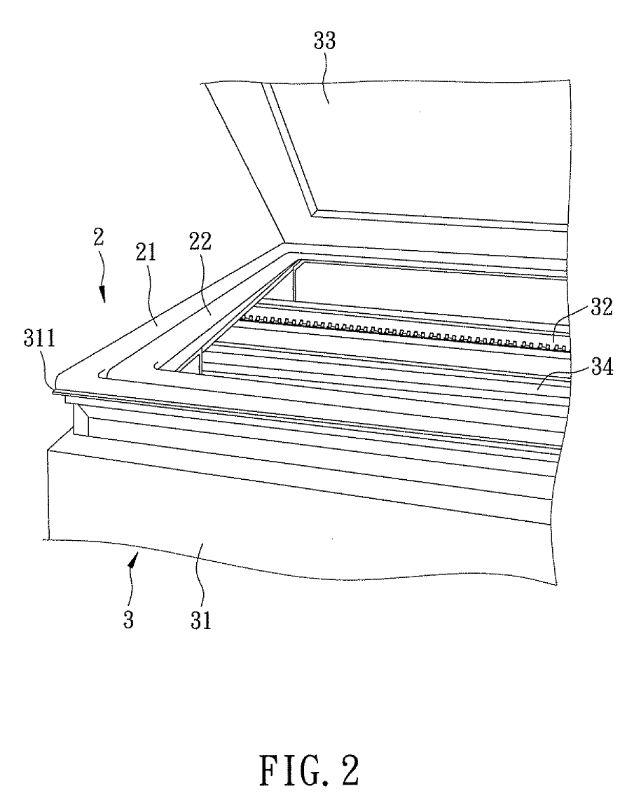

Referring to FIGS. 2 to 5, a heat-insulating sealing device 2 according to the preferred embodiment of the present invention is adapted to be incorporated in a heating furnace which includes a housing 3 and a connecting unit 4 connected to the housing 3. The housing 3 includes a furnace bottom 31, a conveying channel 32 formed in the furnace bottom 31 to convey a circuit board (not shown) an openable top cover 33 covering a top portion of the furnace bottom 31, and a furnace chamber 34 cooperatively defined by the furnace bottom 31 and the top cover 33. The furnace bottom 31 has a looped top face 311 surrounding the furnace chamber 34, and a positioning groove 312 formed in and extending around the top face 311. The connecting unit 4 includes a hinge 41 interconnecting pivotally rear ends of the top cover 33 and the furnace bottom 31, and a pneumatic cylinder 42 connected to front ends of the top cover 33 and the furnace bottom 31.

The heat-insulating sealing device 2 includes inner and outer looped sealing strips 22, 21 that are adapted to be disposed in and around the positioning groove 312, that are adapted to surround the furnace chamber 34, and that are adapted to provide a seal between the top cover 33 and the furnace bottom 31.

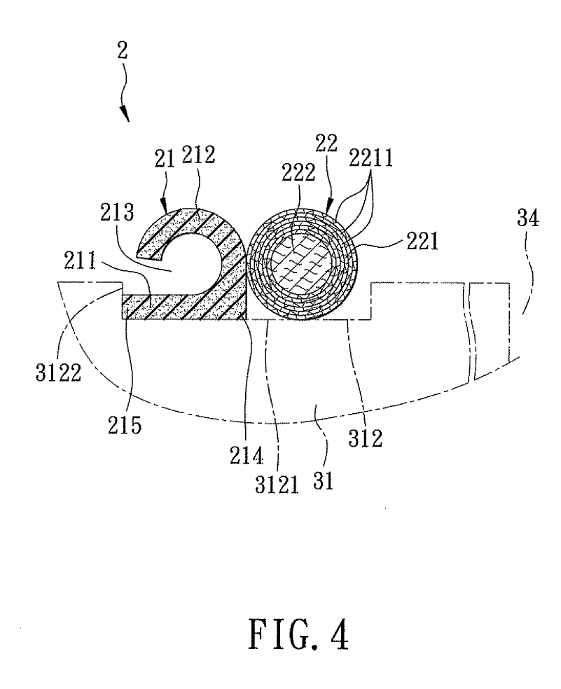

With reference to FIG. 4, the outer looped sealing strip 21 extends around the inner looped sealing strip 22, is adapted to be disposed distal from the furnace chamber 34, and is made of a heat-resistant resilient polymeric material. The heat-resistant resilient polymeric material is rubber or elastomer. In this embodiment, the rubber or elastomer is foamed. The outer looped sealing strip 21 includes a looped base section 211 adapted to be fixed to a groove bottom wall 3121 of the positioning groove 312 and having inner and outer peripheries 214, 215, a looped deformable section 212 extending upwardly from the inner periphery 214 and curving outwardly and downwardly toward the outer periphery 215, and a deformable space 213 formed between the looped base section 211 and the looped deformable section 212 and having an opening. The inner periphery 214 is proximate to the inner looped sealing strip 22. The outer periphery 215 abuts against an outer groove sidewall 3122 of the positioning groove 312. Through the presence of the deformable space 213, the looped deformable section 212 is deformable toward or away from the looped base section 211 so as to enhance deformability of the outer looped sealing strip 21.

In this embodiment, the inner looped sealing strip 22 abuts against an inner side of the outer looped sealing strip 21, is adapted to extend around the furnace chamber 34, and includes a heat-resistant fabric 221, and a rope 222 made of a heat-resistant fiber and entirely wrapped by the heat-resistant fabric 221. The fabric 221 includes a plurality of fabric layers 2211 one surrounding the other and wrapping entirely the rope 222. Because the rope 222 is resilient, the deformability of the inner looped sealing strip 22 is enhanced. Further, the inner looped sealing strip 22 prevents hot air emitting from the furnace chamber 34 from contacting directly the outer looped sealing strip 21, so that heat absorbed by the outer looped sealing strip 21 may be minimized. As a result, a deterioration in the structural integrity of the outer looped sealing strip 21 may be retarded, and hence, the service life of the heat-insulating sealing device 2 may be prolonged.

By increasing the deformability of the outer and inner looped sealing strips 21, 22, the sealing and heat-insulating effects of the present invention may be enhanced.

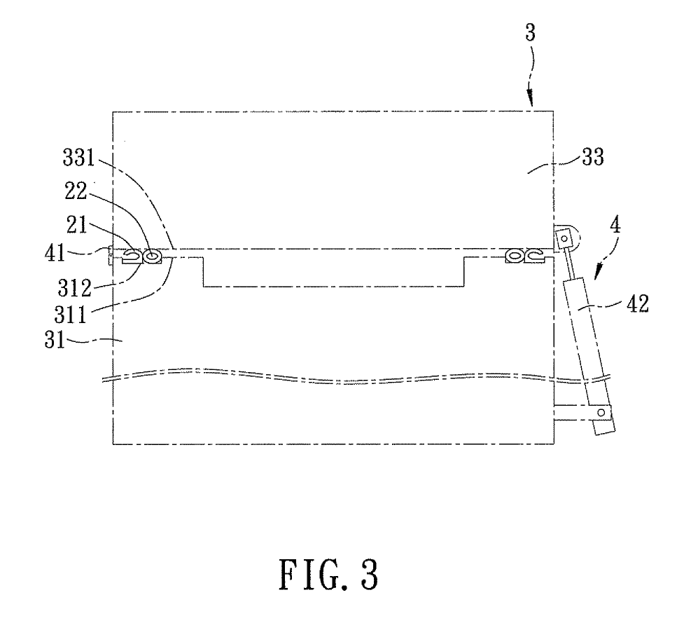

With reference to FIG. 3, in use, when the top cover 33 is pivoted downwardly so as to cover the top portion of the furnace bottom 31, the outer and inner looped sealing strips 21, 22 are pressed between a bottom face 331 of the top cover 33 and the top face 311 of the furnace bottom 31 and are deformed, so that the furnace chamber 34 is insulated and sealed. Thus, the amount of oxygen (in parts per million) inside the nitrogen-filled furnace chamber 34 may be minimized.

To cure a circuit board, the circuit board is conveyed into the furnace chamber 34 through the conveying channel 32, the furnace chamber 34 is heated, and nitrogen gas is introduced into the furnace chamber 34 so as to reduce oxidation of the circuit board. Since the furnace chamber 34 is insulated and sealed through the presence of the heat-insulating sealing device 2, a good curing effect may be obtained, and costs may be minimized.

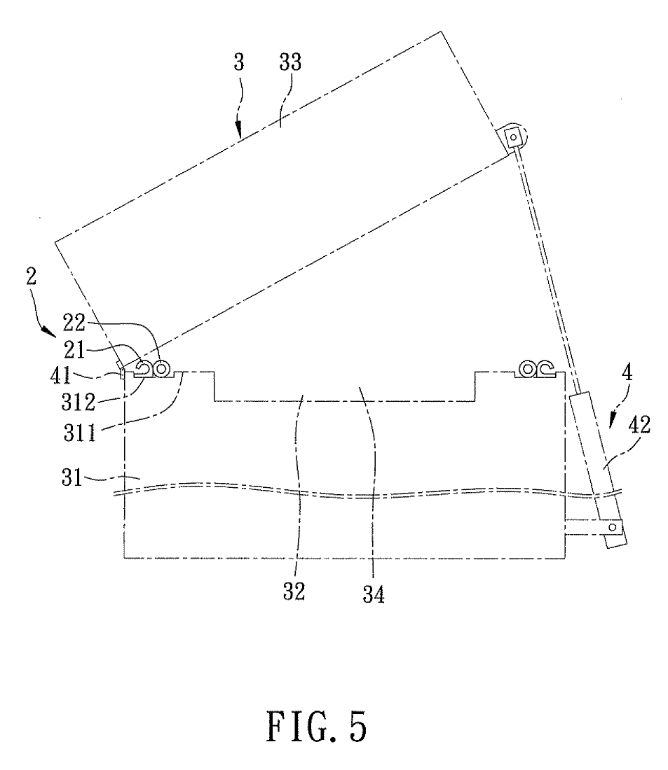

With reference to FIG. 5, to repair the heat-insulating sealing device 2, the pneumatic cylinder 42 is activated, and the top cover 33 is pivoted upwardly relative to the furnace bottom 31 through the hinge 41. At this time, the outer and inner looped sealing strips 21, 22 are released and are therefore no longer pressed and deformed by the top cover 33 and the furnace bottom 31.

To summarize the aforementioned description, since the outer looped sealing strip 21 is made of a material that easily absorbs heat and that easily loses its structural integrity when directly exposed to intense heat, the inner looped sealing strip 22 is used to prevent the outer looped sealing strip 21 from being exposed directly to the heat emitting from the furnace chamber 34. The inner looped sealing strip 22 is made of a material more heat-resistant than that of the outer looped sealing strip 21, and hence, the service life of the outer looped sealing strip 21 is prevented from being reduced. This ensures that the insulating and sealing effect of the heat-insulating sealing device 2 of the present invention is maintained.

While the present invention has been described in connection with what is considered the most practical and preferred embodiment, it is understood that this invention is not limited to the disclosed embodiment but is intended to cover various arrangements included within the spirit and scope of the broadest interpretations and equivalent arrangements.

We claim:

1. A heat-insulating sealing device mountable between a bottom face of an openable top cover and a top face of a furnace bottom of a heating furnace which defines a furnace chamber, said heat-insulating sealing device comprising:
outer and inner looped sealing strips adapted to surround the furnace chamber and adapted to provide a seal between the top cover and the furnace bottom, said outer looped sealing strip extending around said inner looped sealing strip, being made of a heat-resistant resilient polymeric material, and being adapted to be disposed distal from the furnace chamber, said inner looped sealing strip abutting against an inner side of said outer looped sealing strip, being adapted to extend around the furnace chamber, and including a heat-resistant fabric.

2. The heat-insulating sealing device of claim 1, wherein said inner looped sealing strip further includes a rope made of a heat-resistant fiber and entirely wrapped by said heat-resistant fabric.

3. The heat-insulating sealing device of claim 2, wherein said heat-resistant fabric includes a plurality of fabric layers one surrounding the other and wrapping entirely said rope.

4. The heat-insulating sealing device of claim 1, wherein said heat-resistant resilient polymeric material is rubber or elastomer.

5. The heat-insulating sealing device of claim 4, wherein said rubber or elastomer is foamed.

6. The heat-insulating sealing device of claim 3, wherein said outer looped sealing strip includes a looped base section adapted to be attached to the top face of the furnace bottom, and a looped deformable section extending upwardly from an inner periphery of said looped base section and curving outwardly and downwardly toward an outer periphery of said looped base section.
